(19) United States
(12) Patent Application Publication
(10) Pub. No.: US 2012/0109657 A1
(43) Pub. Date: May 3, 2012

(54) Narrative Voice Files for GPS Devices

(76) Inventor: Cristian Partan, (US)

(21) Appl. No.: 12/849,471

(22) Filed: Oct. 30, 2010

(51) Int. Cl. G10L 21/00; G06F 17/30

(52) U.S. Cl. 704/270; 707/792; 707/E17.101; 707/E17.044; 704/E21.001

(57) ABSTRACT

The invention consists of a compilation of unified audio tour files in compressed format i.e. MP3 or MP4 that provides pre-recorded spoken commentary to Global Positioning System (GPS) enabled devices. Using satellite technology, audio is triggered based on a user's location, providing relevant facts, geography, points of interest, history, and trivia of every city/town/area as it is being traveled throughout the World. These audio tour files will be provided in multiple languages. Upgrades shall be available via the Internet. The invention will narrate the entire World beginning with the large metropolitan areas of the United States of America, through to the smallest towns in Malta.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of providing manufacturers of Global Positioning System (GPS) enabled devices with audio tour files. More particularly, the present invention is in the technical field of providing GPS enabled devices with narrative voice files that describe a particular area as it is being traveled.

Conventional GPS devices, such as smart phones, handheld devices, vehicle GPS, do not have the ability to provide the traveler with a succinctly packaged, pre-recorded spoken commentary consisting of relevant facts, geography, points of interest, history, and trivia of every city/town/area as it is being traveled throughout the World. Travelers often are interested in such information while traveling through unfamiliar regions. These audio narratives shall also be provided in multiple languages. Manufacturers of the various GPS enabled devices will implement software that trigger the narratives audio files as the area is being traversed. Updated audio can be downloaded via the Internet in MP3 format.

### BRIEF SUMMARY OF THE INVENTION

Current GPS enabled devices lack the capability of providing an audio tour or “virtual tour guide” to the traveler, which narrates the local geography, facts, history, trivia, points of interest and regional industry as it is being traversed throughout the entire World.

### BRIEF DESCRIPTION OF THE SEVERAL VIEWS OF THE DRAWING

Not Applicable

### DETAILED DESCRIPTION OF THE INVENTION

Using GPS satellite technology, audio content is triggered based on a traveler's location. The audio tour files shall be recorded via a microphone onto a computer and saved in MP3 or comparable format. The information for the audio files shall be provided by locals of that region and through the use of websites such as Wikipedia. Competitions shall be held amongst local participating schools to determine the best narratives for the region. These audio tour files will be recorded in multiple languages and triggered by software from the GPS manufacturers. The information narrated shall include but not be exclusive to local geography, facts, history, trivia, points of interest, regional industry, calendar of events.

Audio tours already exist in remote handheld devices to visitors of certain attractions through bus, walking, and train tours. They provide location relevant information to visitors depending on who they are, where they are, and what they are viewing. The difference in this invention is that it will not be exclusive to certain attractions but provide a virtual audio tour guide to the entire World.

Anyone will be able to use this invention by simply activating it through their GPS enabled device. The audio tour invention would automatically be overridden by driving direction commands and then continue after such commands have ended. The invention will keep travelers entertained and informed during road trips while locals suggest points of interest. Various local dialects and accents shall be used representing each distinct area.

Initially, most of the data for the audio tours can be garnished via the internet but eventually, contests among various local educational institutions will be held to determine the most accurate and entertaining audio tour for that region. Those institutions shall be credited in the narration. Local celebrities will be recruited to provide the narration.

The audio tour will be triggered as the traveler approaches a point of interest for that area. An example of the audio tour as the traveler enters a city: “You just entered the Huntsville, Alabama Metropolitan Area. The population was estimated at 400,000 by the 2000 census. It was first named Twickenham after Alexander Pope's home in England but later named after John Hunt, its first settler. Huntsville is nicknamed the ‘Rocket City’ because of its close history with U.S. space missions”. The traveler will have the option of silencing the audio tour without deactivating the audible GPS driving commands.

What is claimed is:

1. A system of developing, compiling and storing pre-recorded (MP3 or MP4 format) spoken audio tour commentary comprising: relevant facts, geography, points of interest, history, calendar of events and trivia of every city/town/area in the World; said audio tour files can be downloaded/upgraded via the Internet based on the location of the user.

2. A method of Global Position System (GPS) enabled devices to access the system in claim 1 wherein said audio tour files are triggered based on the traveler's location.
